(19) United States
(12) Patent Application Publication
(10) Pub. No.: US 2025/0225624 A1
(43) Pub. Date: Jul. 10, 2025

(54) ALIAS-FREE DIFFUSION MODELS

(71) Applicant: NVIDIA Corp., Santa Clara, CA (US)

(72) Inventors: Arash Vahdat, San Mateo, CA (US); Morteza Mardani, San Jose, CA (US); Karsten Julian Kreis, Vancouver (CA)

(73) Assignee: NVIDIA Corp., Santa Clara, CA (US)

(21) Appl. No.: 19/011,380

(22) Filed: Jan. 6, 2025

Related U.S. Application Data
(60) Provisional application No. 63/619,013, filed on Jan. 9, 2024.

(51) Int. Cl. G06T 5/60; G06T 5/70; G06T 11/40

(52) U.S. Cl. CPC G06T 5/60; G06T 5/70; G06T 11/40; G06T 2207/20081; G06T 2207/20084

(57) ABSTRACT

Alias-free diffusion neural network models configured to convert input Gaussian noise and additional conditioning signals to images or video utilizing translation equivariant layers and noise signals generated by continuous Gaussian processes. The models may comprise a U-net encoder/decoder structure with noise samples derived from a Gaussian process using techniques such as Random Fourier Features approximation.

### CROSS-REFERENCE TO RELATED APPLICATIONS

This application claims priority and benefit under 35 U.S.C. 119 (e) to U.S. Application Ser. No. 63/619,013, “Alias-Free Diffusion Models”, filed on Jan. 9, 2024, the contents of which are incorporated herein by reference in their entirety.

### BACKGROUND

Diffusion models refer to a class of generative models that learn to generate data by denoising. These models may implement two processes: (1) a forward process that adds increments of Gaussian noise to an input over repeated steps, and (2) a reverse generative process that transforms the noise into an output by iterative denoising.

Gaussian noise, also known as white noise, is a random signal that exhibits statistical properties following a Gaussian distribution, often referred to as a normal distribution. It is a type of noise that has a random distribution of values centered around zero with equal probability of positive and negative values. Gaussian noise is characterized by its constant power spectral density across all frequencies, making it have a flat frequency response. Gaussian noise is commonly encountered in signal processing and image processing applications. The random nature of Gaussian noise makes it useful for simulating and analyzing the effects of random disturbances or errors in systems. Gaussian noise may be added to images/video to mimic real-world noise sources and evaluate the performance of algorithms or systems under different noise conditions. Diffusion models may be utilized to inject Gaussian noise and additional conditioning signals into images or video.

Image generating artificial intelligence networks that utilize diffusion modelling may first generate a random (technically, pseudo-random) image in the model's latent space. A noise predictor then estimates the noise of the image. The predicted noise is subtracted from the image. This process is repeated to eventually generate a final (clean) output image. “Sampling” in this context is the process of generating a new sample image at processing at each iteration. The logic utilized to carry out sampling may be referred to as the ‘sampler’.

Conventional diffusion models for image and video generation exhibit aliasing effects in their output. These effects often manifest themselves in the form of texture-sticking or flickering artifacts in moving images. Conventionally, these artifacts are removed via ad-hoc post-processing steps such as by applying additional neural networks trained to filter out the artifacts.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an embodiment of an alias-free residual denoising U-Net network.

FIG. 2 depicts a parallel processing unit 202 in accordance with one embodiment.

FIG. 3 depicts a general processing cluster 300 in accordance with one embodiment.

FIG. 4 depicts a memory partition unit 400 in accordance with one embodiment.

FIG. 5 depicts a streaming multiprocessor 500 in accordance with one embodiment.

FIG. 6 depicts a processing system 600 in accordance with one embodiment.

FIG. 7 depicts an exemplary processing system 700 in accordance with another embodiment.

FIG. 8 depicts a graphics processing pipeline 800 in accordance with one embodiment.

### DETAILED DESCRIPTION

Disclosed herein are alias-free diffusion models utilizing injected Gaussian noise for image and video generation. The disclosed mechanisms have applications including image and video super-resolution, video-to-video translation, 360 panorama generation, and image and video generation in general. The disclosed mechanisms may generate higher quality samples than conventional approaches.

The disclosed mechanisms utilize alias-free diffusion models that are translation equivariant with regards to their inputs. These models operate such that translations (changes in coordinates) of input noise, and conditioning of the output, does not introduce aliasing or flickering artifacts. The models may utilize a functional encoding of the input and provide translation equivariance under continuous translations of the input encoding. Gaussian noise distributions cannot be represented as a continuous function, and therefore the alias-free diffusion models may instead utilize Gaussian processes.

A Gaussian process is a stochastic process that defines a distribution over functions. A Gaussian process comprises a collection of randomized values, in which any finite subset thereof follows a multivariate Gaussian distribution. Gaussian processes provide a mechanism for non-parametric regression and probabilistic modeling by leveraging the properties of Gaussian distributions in defining relationships between data points. A Gaussian process is specified by a mean function m(x) and a covariance function k(x, x′). For any set of input points {x_1, x_2, . . . , x_n}, the output {y_1, y_2, . . . , y_n} follows a multivariate normal distribution.

The mean function m(x) represents an expected value of the process at any input x. The mean function may be assumed to be zero in some Gaussian processes. The covariance function defines the covariance between the process values at any two inputs x and x′. Choices for the covariance function include the squared exponential (Gaussian) kernel and the Matérn kernel.

Gaussian processes apply a set of sampled data points to predict the function values at new points. The joint distribution of the known points and the new points is assumed to be Gaussian, allowing the conditional distribution (the prediction) to also be Gaussian. The posterior mean and covariance of the new points are computed using the sampled data and the Gaussian process prior. This provides both a predicted mean function and uncertainty estimate at each new point.

A translation equivariant object or function behaves in a consistent manner under translations or shifts in the input space. In other words, upon a shift in the input signals, the output signals shift accordingly. One example involves an image and a convolutional neural network (CNN) applied to an image. If the CNN is translation equivariant, a translation of the input image (shifting it horizontally, vertically, or both) results in the output of the CNN exhibiting a matching translation.

In a translation-equivariant system, the relationship between input and output remains unchanged by the translation operation. This property is useful for example in computer vision tasks where objects or patterns of interest may appear at different locations in an image. Translation equivariance allows the system to detect the objects or patterns regardless of their position. Implementing translation equivariance may enable consistent outputs in the presence of spatial or temporal variations in the inputs.

The training of an alias-free diffusion model may be implemented using function-space diffusion models or function-space flow matching models. In one embodiment a denoising model may be trained by minimizing the relationship:

$${min}_{ϕ} {𝔼}_{t ∼ u [ 0 , 1 ] , {x}_{0} ∼ v , g ∼ 𝒢 P ( 0 , c )} [ {λ}_{t} {‖ {x}_{0} - {D}_{ϕ} ( {α}_{t} {x}_{0} + {σ}_{t} g , t ) ‖}^{2} ] \qquad Equation 1$$

where t∈[0, 1] is a time parameter randomly sampled from a uniform distribution, v is a input distribution to sample, and x₀ is a continuous function randomly sampled from the input distribution. The parameter g represents a Gaussian process randomly (technically, pseudo-randomly) selected from a set of such functions and comprising a covariance function C and a zero mean function. In general, references to random operations herein should be understood to include pseudo-random operations in implementations wherein generation of true pure randomness is impractical.
D_{θ}(αₜx₀+σ_{g}, t) is a denoising model that is trained (configured) to predict a clean (denoised) version of an input that is perturbed with varying degrees of noise.

Parameter λₜ is a time-dependent weighting mechanism, σₜ is a time-dependent injected noise schedule, and αₜ is a time-dependent input rescaling coefficient. In one embodiment, αₜ=\sqrt{1−σₜ²}. In one embodiment, σₜ may be determined by: σₜ==sin (0.5πt).

The selected Gaussian process may utilize a covariance function C comprising an RBF (radial basis function) kernel such as:

$$C ( {u}_{1} , {u}_{2} ) = exp ( - \frac{{‖ {u}_{1} - {u}_{2} ‖}^{2}}{2 {ℓ}^{2}} ) \qquad Equation 2$$

where [symbol] is a scale parameter and u is a positional variable.

The covariance function, also known as a kernel function or covariance kernel, quantifies the covariance, or the statistical measure of the linear relationship, between two values. The covariance function defines the similarity or correlation between different data points in the Gaussian process. The covariance function processes input variables into a covariance metric between corresponding output variables. It measures how the outputs of the data points relate to each other based on the inputs. The covariance function may be utilized to model the underlying structure or patterns in the variables, enabling predictions or inference about unobserved values. Covariance functions come in various forms, such as the squared exponential covariance function, Matérn covariance function, or periodic covariance function. The choice of covariance function depends on the specific problem and the characteristics of the data being modeled, as different covariance functions capture different patterns or smoothness characteristics.

Fourier approximation is a mechanism that represents a function as a sum of sinusoidal functions with different frequencies and amplitudes. It is based on the Fourier series, which expresses a periodic function as an infinite sum of sine and cosine functions. The Fourier series representation of a function involves breaking down the function into its constituent frequencies. Each frequency component is represented by a sinusoidal function with a specific amplitude and phase. By summing up these frequency components, the original function is approximated as a sum of discrete terms. In practice, Fourier approximation can be performed using techniques such as the discrete Fourier transform (DFT) or the fast Fourier transform (FFT), which are efficient algorithms for calculating the Fourier series coefficients. These coefficients capture the amplitudes and phases of the sinusoidal components.

Random Fourier Features (RFF) calculation is a technique used to approximate the computation of the kernel trick in kernel methods, such as kernel support vector machines (SVMs) or kernel ridge regression. It takes advantage of the fact that certain kernel functions may be efficiently approximated using Random Fourier Features, making the computations faster and more scalable. In many kernel methods, the computation of the kernel function involves evaluating the pairwise similarity between each pair of data points in the dataset. This may be computationally expensive, especially for large datasets. Random Fourier Features provides an alternative approach to approximate the kernel function in a lower-dimensional feature space, reducing the computational complexity. Random Fourier Features applies a random projection that maps the original input space into a higher (possibly infinite) dimensional feature space. The random projection is designed in such a way that it approximates the kernel function. By using the random projection, the computation of the kernel function may be approximated as a simple inner product in the higher-dimensional space, which is computationally efficient. Random Fourier Features are particularly useful when the kernel function exhibits certain properties, such as being shift-invariant or translation-invariant, which allows for the efficient approximation using Fourier features. By employing Random Fourier Features, the dimensionality of the feature space may be reduced, leading to faster computation and scalability while maintaining a reasonable level of accuracy in many applications of kernel methods.

The Random Fourier Features outputs may be low-pass filtered to remove high-frequency components that introduce aliasing. To avoid aliasing artifacts, the frequency coefficient (ϕ) in Equation 3 below should not exceed the Nyquist frequency.

In one embodiment of the disclosed mechanisms, samples from a Gaussian process may be generated using Fourier approximation. They may be also generated efficiently using the Random Fourier Features technique by constructing random features:

$${ϕ}_{i} ( u ) = \sqrt{\frac{2}{N}} cos ( {Ψ}_{i}^{T} u + {τ}_{i} ) \qquad Equation 3$$

where

$${τ}_{i} ∼ U [ 0 , 2 π ] and {ψ}_{i} ∼ N ( 0 , \frac{1}{{ℓ}^{2}} I )$$

for a Random Fourier Features kernel with the scale [symbol] and the positional variable u. A random Gaussian process may be constructed as:

$$g ( u ) = {\sum }_{i = 1}^{N} {ω}_{i} {ϕ}_{i} ( u ) , where {ω}_{i} = N ( 0 , 1 ) \qquad Equation 4$$

The parameters l and the distribution of ψ should be chosen to avoid generation of aliasing effects.

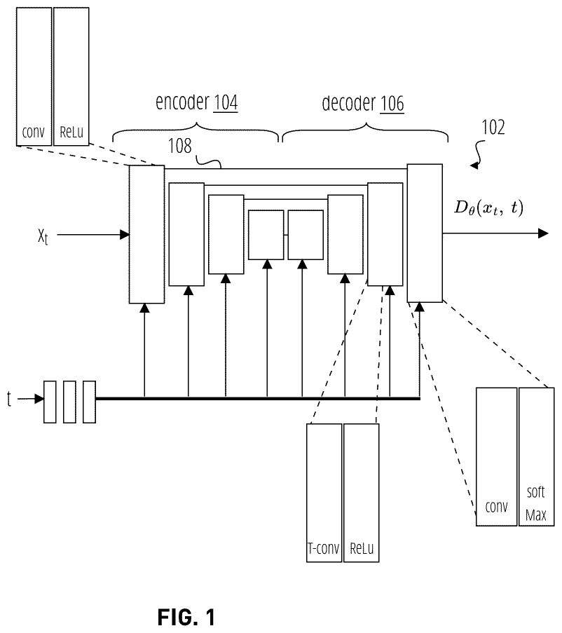

FIG. 1 depicts an embodiment of an alias-free residual denoising U-net network 102 that transforms a perturbed input xₜ and time step parameter t into a predicted denoising model D_{θ}(xₜ, t). The U-Net neural network derives its name from its shape, which resembles the letter “U”. It comprises an encoder 104 and a decoder 106. The encoder 104 comprises successive convolutional layers that downsample the dimensions of the input tensor, encoding its high-level features. Each convolutional layer may be followed for example by a rectified linear unit (ReLU) activation function to introduce non-linearity. As the encoder path progresses through the network, the resolution decreases while the number of feature channels increases. This effectively condenses the contextual information of the image into fewer channels.

The decoder 106, which follows after the encoder 104, reconstructs the original input tensor resolution from the condensed information. The decoder 106 comprises upsampling layers, usually transposed convolutions or bilinear upsampling, combined with skip connections 108 from the corresponding layers in the encoder path. The decoder 106 layers may for example be configured with ReLu (Rectified Linear Unit) or SiLu (Sigmoid Linear Unit) activations.

Skip connections enable the decoder 106 to leverage the high-resolution, low-level features learned by the encoder 104, preserving finer details during the upsampling process. To combine the information from the skip connections and the upsampling layers, concatenation (not depicted) may be applied. This enables the decoder 106 to exploit both high-level and low-level features, promoting localization accuracy.

The decoder 106 path may terminate with a 1×1 convolutional layer followed by a suitable activation function, such as sigmoid or Softmax. The output assigns a probability/prediction to regions or values of the input, indicating its likelihood of belonging to a specific class or category (e.g., noise or not). Overall, the U-Net architecture's symmetrical structure with skip connections enables it to effectively leverage both global contextual information and local details.

One or both of the encoder 104 and decoder 106 may also comprise normalization layers (not depicted).

The perturbed input xₜ and time variable t are transformed the by the network into a denoising model prediction D_{θ}(xₜ, t). The U-net network 102 may be translation equivariant.

A Denoising Diffusion Implicit Model (DDIM) is an advanced generative model useful for image synthesis. It is a type of diffusion model that generates a final output through a sequence of gradual transformations, generally starting from noise and converging to a clean image.

In a forward process, Gaussian noise is added to the input image over several steps to progressively corrupt it. In a reverse process, the model learns to denoise the corrupted inputs to reconstruct the original input. This process is guided by a neural network trained to reverse the diffusion steps. Unlike other types of diffusion models, DDIM may employ a non-Markovian process for the reverse process, specifically deterministic mappings between iterations, making the sample paths smoother and consistent. Instead of explicitly reversing each noise addition step, DDIM learns to estimate intermediate states. This reduces the number of required denoising steps, thereby speeding up generation without significant loss in quality.

A Denoising Diffusion Implicit Model (DDIM) may be used to generate samples, in one embodiment. A DDIM is sampler that utilizes the algorithm depicted in Equation 5 below to generate samples with a trained U-Net denoising model (D_{θ}(xₜ, t)).

The DDIM may apply the denoising model to approximate a final image with the denoised image produced at each step. The samples (image or video) generated by the model at the inference time may be generated using function space diffusion models or function-space flow matching frameworks. One embodiment of the disclosed mechanisms utilizes a DDIM sampler that determines an updated image sample for processing through the denoising network from one time step t to the next time step s and t where 0<s<t<1 as follows:

$${x}_{s} = {σ}_{s} ( \frac{{α}_{s}}{{σ}_{s}} - \frac{{α}_{t}}{{σ}_{t}} ) {D}_{0} ( {x}_{t} , t ) + \frac{{σ}_{s}}{{σ}_{t}} {x}_{t} \qquad Equation 5$$

The DDM may generate the initial sample x₁ as x₁˜ [symbol] P(0,C) and iteratively generate xₛ from xₜ where s:=t−Δt and Δt is a small step size.

The upsampling layers of the decoder 106 may in one embodiment be implemented using a sinc interpolation kernel. The downsampling layers of the encoder 104 may be implemented with strided (stride>1) sampling and a low-pass filter front-end to omit high-frequency spectrum from the input to the strided sampling layer. Commonly utilized non-linear activations such as ReLU and Swish, and normalization layers such as layer norm may introduce high-frequency components that generate aliasing artifacts. These artifacts may be avoided by first upsampling the signal and then applying (e.g., via skip connections 108) the activations/norms in the upsampled domain before downsampling again.

In one embodiment, the denoising model may be constructed from a neural network such as the U-net network 102 above, and it may be trained to be equivariant via data augmentation. The denoising model may be trained by minimizing:

$${min}_{θ} {‖ T ( {D}_{θ} ( {x}_{t} , t ) ) - {D}_{θ} ( T ( {x}_{t} ) , t ) ‖}_{2}^{2} \qquad Equation 6$$

where T is a random translation or affine transformation.

Embodiments alias-free diffusion model noise and image generators and processes as disclosed herein may be implemented as logic on computing devices utilizing one or more graphic processing unit (GPU) and/or general purpose data processor (e.g., a 'central processing unit or CPU). Exemplary architectures will now be described that may be configured by those of ordinary skill in the art to implement the mechanisms and processes disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

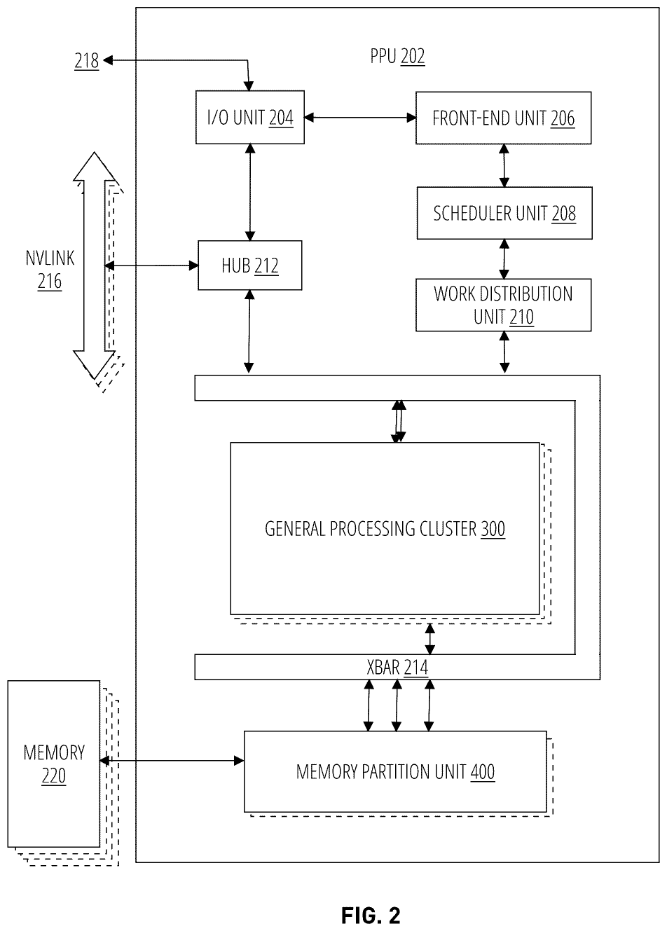

FIG. 2 depicts a parallel processing unit 202, in accordance with an embodiment. In an embodiment, the parallel processing unit 202 is a multi-threaded processor that is implemented on one or more integrated circuit devices. The parallel processing unit 202 is a latency hiding architecture designed to process many threads in parallel. A thread (e.g., a thread of execution) is an instantiation of a set of instructions configured to be executed by the parallel processing unit 202. In an embodiment, the parallel processing unit 202 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 202 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 202 modules may be configured to accelerate thousands of High Performance Computing (HPC), data center, and machine learning applications. The parallel processing unit 202 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 2, the parallel processing unit 202 includes an I/O unit 204, a front-end unit 206, a scheduler unit 208, a work distribution unit 210, a hub 212, a crossbar 214, one or more general processing cluster 300 modules, and one or more memory partition unit 400 modules. The parallel processing unit 202 may be connected to a host processor or other parallel processing unit 202 modules via one or more high-speed NVLink 216 interconnects. The parallel processing unit 202 may be connected to a host processor or other peripheral devices via an interconnect 218. The parallel processing unit 202 may also be connected to a local memory comprising a number of memory 220 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 220 may comprise logic to configure the parallel processing unit 202 to carry out aspects of the techniques disclosed herein.

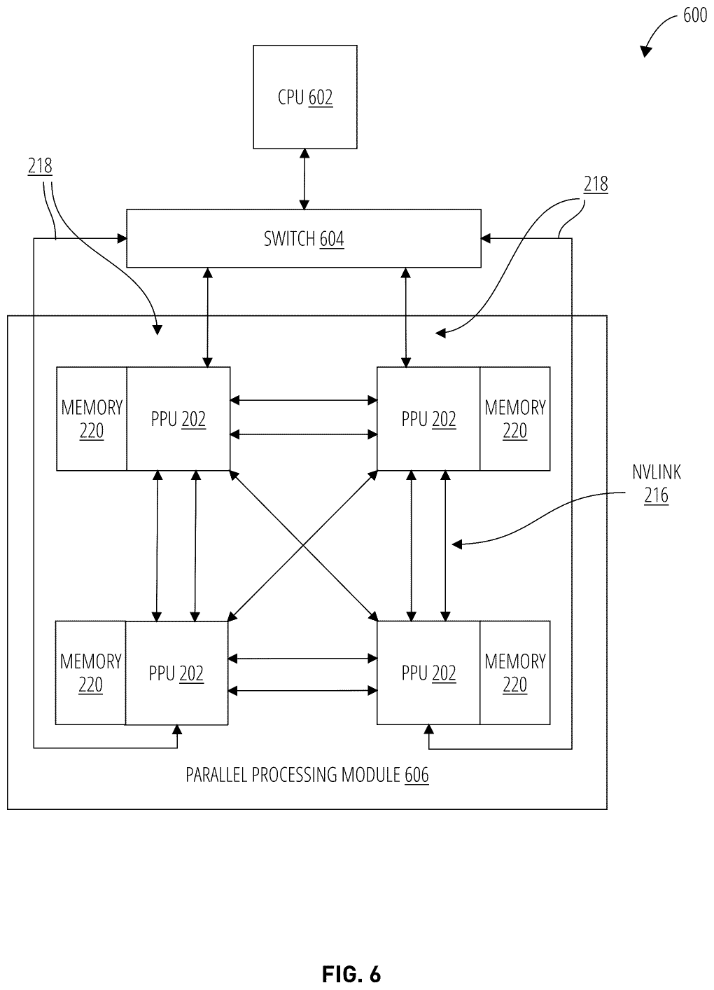

The NVLink 216 interconnect enables systems to scale and include one or more parallel processing unit 202 modules combined with one or more CPUs, supports cache coherence between the parallel processing unit 202 modules and CPUs, and CPU mastering. Data and/or commands may be transmitted by the NVLink 216 through the hub 212 to/from other units of the parallel processing unit 202 such as one or more copy engines, a video encoder, a video decoder, a power management unit, etc. (not explicitly shown). The NVLink 216 is described in more detail in conjunction with FIG. 6.

The I/O unit 204 is configured to transmit and receive communications (e.g., commands, data, etc.) from a host processor (not shown) over the interconnect 218. The I/O unit 204 may communicate with the host processor directly via the interconnect 218 or through one or more intermediate devices such as a memory bridge. In an embodiment, the I/O unit 204 may communicate with one or more other processors, such as one or more parallel processing unit 202 modules via the interconnect 218. In an embodiment, the I/O unit 204 implements a Peripheral Component Interconnect Express (PCIe) interface for communications over a PCIe bus and the interconnect 218 is a PCIe bus. In alternative embodiments, the I/O unit 204 may implement other types of well-known interfaces for communicating with external devices.

The I/O unit 204 decodes packets received via the interconnect 218. In an embodiment, the packets represent commands configured to cause the parallel processing unit 202 to perform various operations. The I/O unit 204 transmits the decoded commands to various other units of the parallel processing unit 202 as the commands may specify. For example, some commands may be transmitted to the front-end unit 206. Other commands may be transmitted to the hub 212 or other units of the parallel processing unit 202 such as one or more copy engines, a video encoder, a video decoder, a power management unit, etc. (not explicitly shown). In other words, the I/O unit 204 is configured to route communications between and among the various logical units of the parallel processing unit 202.

In an embodiment, a program executed by the host processor encodes a command stream in a buffer that provides workloads to the parallel processing unit 202 for processing. A workload may comprise several instructions and data to be processed by those instructions. The buffer is a region in a memory that is accessible (e.g., read/write) by both the host processor and the parallel processing unit 202. For example, the I/O unit 204 may be configured to access the buffer in a system memory connected to the interconnect 218 via memory requests transmitted over the interconnect 218. In an embodiment, the host processor writes the command stream to the buffer and then transmits a pointer to the start of the command stream to the parallel processing unit 202. The front-end unit 206 receives pointers to one or more command streams. The front-end unit 206 manages the one or more streams, reading commands from the streams and forwarding commands to the various units of the parallel processing unit 202.

The front-end unit 206 is coupled to a scheduler unit 208 that configures the various general processing cluster 300 modules to process tasks defined by the one or more streams. The scheduler unit 208 is configured to track state information related to the various tasks managed by the scheduler unit 208. The state may indicate which general processing cluster 300 a task is assigned to, whether the task is active or inactive, a priority level associated with the task, and so forth. The scheduler unit 208 manages the execution of a plurality of tasks on the one or more general processing cluster 300 modules.

The scheduler unit 208 is coupled to a work distribution unit 210 that is configured to dispatch tasks for execution on the general processing cluster 300 modules. The work distribution unit 210 may track a number of scheduled tasks received from the scheduler unit 208. In an embodiment, the work distribution unit 210 manages a pending task pool and an active task pool for each of the general processing cluster 300 modules. The pending task pool may comprise a number of slots (e.g., 32 slots) that contain tasks assigned to be processed by a particular general processing cluster 300. The active task pool may comprise a number of slots (e.g., 4 slots) for tasks that are actively being processed by the general processing cluster 300 modules. As a general processing cluster 300 finishes the execution of a task, that task is evicted from the active task pool for the general processing cluster 300 and one of the other tasks from the pending task pool is selected and scheduled for execution on the general processing cluster 300. If an active task has been idle on the general processing cluster 300, such as while waiting for a data dependency to be resolved, then the active task may be evicted from the general processing cluster 300 and returned to the pending task pool while another task in the pending task pool is selected and scheduled for execution on the general processing cluster 300.

The work distribution unit 210 communicates with the one or more general processing cluster 300 modules via crossbar 214. The crossbar 214 is an interconnect network that couples many of the units of the parallel processing unit 202 to other units of the parallel processing unit 202. For example, the crossbar 214 may be configured to couple the work distribution unit 210 to a particular general processing cluster 300. Although not shown explicitly, one or more other units of the parallel processing unit 202 may also be connected to the crossbar 214 via the hub 212.

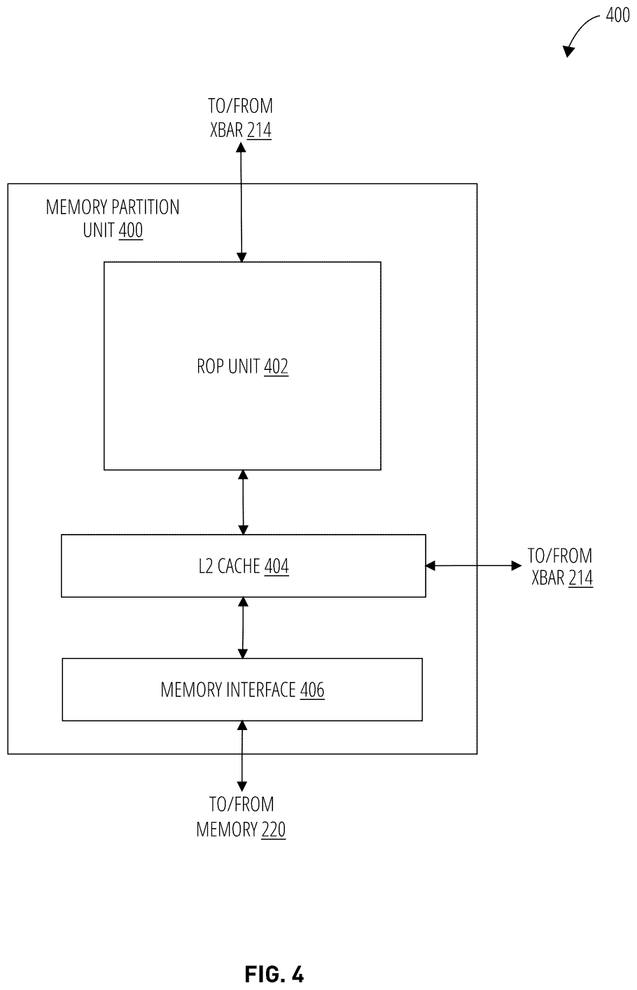

The tasks are managed by the scheduler unit 208 and dispatched to a general processing cluster 300 by the work distribution unit 210. The general processing cluster 300 is configured to process the task and generate results. The results may be consumed by other tasks within the general processing cluster 300, routed to a different general processing cluster 300 via the crossbar 214, or stored in the memory 220. The results can be written to the memory 220 via the memory partition unit 400 modules, which implement a memory interface for reading and writing data to/from the memory 220. The results can be transmitted to another parallel processing unit 202 or CPU via the NVLink 216. In an embodiment, the parallel processing unit 202 includes a number U of memory partition unit 400 modules that is equal to the number of separate and distinct memory 220 devices coupled to the parallel processing unit 202. A memory partition unit 400 will be described in more detail below in conjunction with FIG. 4.

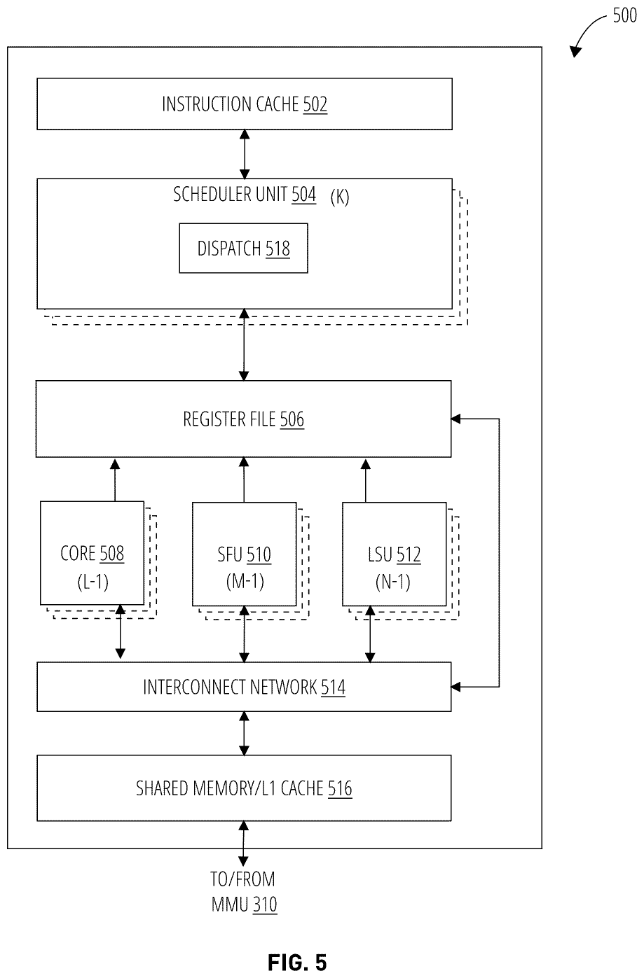

In an embodiment, a host processor executes a driver kernel that implements an application programming interface (API) that enables one or more applications executing on the host processor to schedule operations for execution on the parallel processing unit 202. In an embodiment, multiple compute applications are simultaneously executed by the parallel processing unit 202 and the parallel processing unit 202 provides isolation, quality of service (QoS), and independent address spaces for the multiple compute applications. An application may generate instructions (e.g., API calls) that cause the driver kernel to generate one or more tasks for execution by the parallel processing unit 202. The driver kernel outputs tasks to one or more streams being processed by the parallel processing unit 202. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 5.

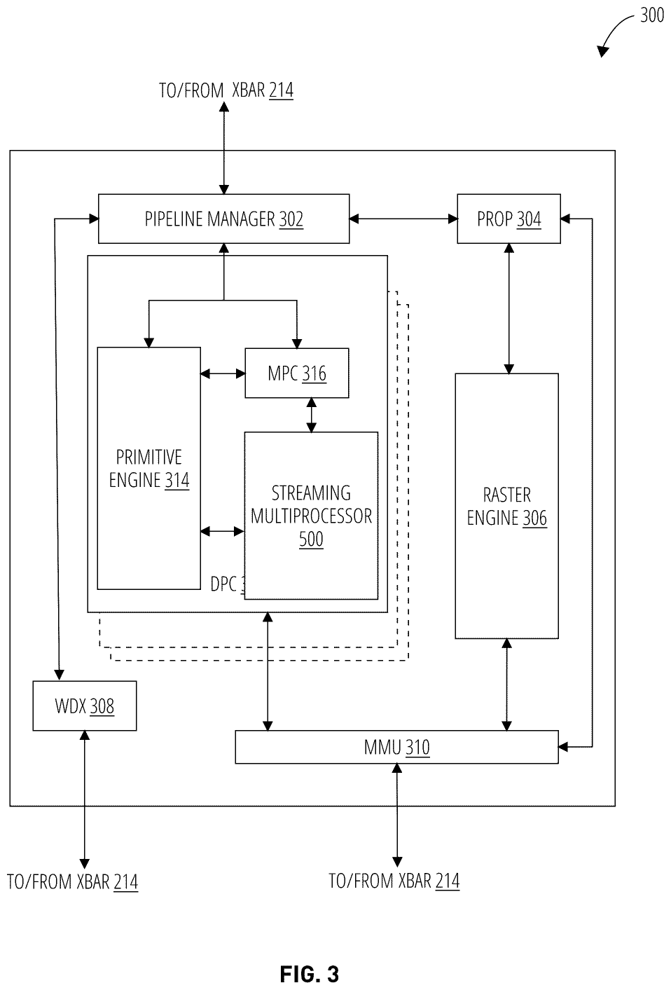

FIG. 3 depicts a general processing cluster 300 of the parallel processing unit 202 of FIG. 2, in accordance with an embodiment. As shown in FIG. 3, each general processing cluster 300 includes a number of hardware units for processing tasks. In an embodiment, each general processing cluster 300 includes a pipeline manager 302, a pre-raster operations unit 304, a raster engine 306, a work distribution crossbar 308, a memory management unit 310, and one or more data processing cluster 312. It will be appreciated that the general processing cluster 300 of FIG. 3 may include other hardware units in lieu of or in addition to the units shown in FIG. 3.

In an embodiment, the operation of the general processing cluster 300 is controlled by the pipeline manager 302. The pipeline manager 302 manages the configuration of the one or more data processing cluster 312 modules for processing tasks allocated to the general processing cluster 300. In an embodiment, the pipeline manager 302 may configure at least one of the one or more data processing cluster 312 modules to implement at least a portion of a graphics rendering pipeline. For example, a data processing cluster 312 may be configured to execute a vertex shader program on the programmable streaming multiprocessor 500. The pipeline manager 302 may also be configured to route packets received from the work distribution unit 210 to the appropriate logical units within the general processing cluster 300. For example, some packets may be routed to fixed function hardware units in the pre-raster operations unit 304 and/or raster engine 306 while other packets may be routed to the data processing cluster 312 modules for processing by the primitive engine 314 or the streaming multiprocessor 500. In an embodiment, the pipeline manager 302 may configure at least one of the one or more data processing cluster 312 modules to implement a neural network model and/or a computing pipeline.

The pre-raster operations unit 304 is configured to route data generated by the raster engine 306 and the data processing cluster 312 modules to a Raster Operations (ROP) unit, described in more detail in conjunction with FIG. 4. The pre-raster operations unit 304 may also be configured to perform optimizations for color blending, organize pixel data, perform address translations, and the like.

The raster engine 306 includes a number of fixed function hardware units configured to perform various raster operations. In an embodiment, the raster engine 306 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 306 comprises fragments to be processed, for example, by a fragment shader implemented within a data processing cluster 312.

Each data processing cluster 312 included in the general processing cluster 300 includes an M-pipe controller 316, a primitive engine 314, and one or more streaming multiprocessor 500 modules. The M-pipe controller 316 controls the operation of the data processing cluster 312, routing packets received from the pipeline manager 302 to the appropriate units in the data processing cluster 312. For example, packets associated with a vertex may be routed to the primitive engine 314, which is configured to fetch vertex attributes associated with the vertex from the memory 220. In contrast, packets associated with a shader program may be transmitted to the streaming multiprocessor 500.

The streaming multiprocessor 500 comprises a programmable streaming processor that is configured to process tasks represented by a number of threads. Each streaming multiprocessor 500 is multi-threaded and configured to execute a plurality of threads (e.g., 32 threads) from a particular group of threads concurrently. In an embodiment, the streaming multiprocessor 500 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 500 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 500 will be described in more detail below in conjunction with FIG. 5.

The memory management unit 310 provides an interface between the general processing cluster 300 and the memory partition unit 400. The memory management unit 310 may provide translation of virtual addresses into physical addresses, memory protection, and arbitration of memory requests. In an embodiment, the memory management unit 310 provides one or more translation lookaside buffers (TLBs) for performing translation of virtual addresses into physical addresses in the memory 220.

FIG. 4 depicts a memory partition unit 400 of the parallel processing unit 202 of FIG. 2, in accordance with an embodiment. As shown in FIG. 4, the memory partition unit 400 includes a raster operations unit 402, a level two cache 404, and a memory interface 406. The memory interface 406 is coupled to the memory 220. Memory interface 406 may implement 32, 64, 128, 1024-bit data buses, or the like, for high-speed data transfer. In an embodiment, the parallel processing unit 202 incorporates U memory interface 406 modules, one memory interface 406 per pair of memory partition unit 400 modules, where each pair of memory partition unit 400 modules is connected to a corresponding memory 220 device. For example, parallel processing unit 202 may be connected to up to Y memory 220 devices, such as high bandwidth memory stacks or graphics double-data-rate, version 5, synchronous dynamic random access memory, or other types of persistent storage.

In an embodiment, the memory interface 406 implements an HBM2 memory interface and Y equals half U. In an embodiment, the HBM2 memory stacks are located on the same physical package as the parallel processing unit 202, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 220 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 202 modules process very large datasets and/or run applications for extended periods.

In an embodiment, the parallel processing unit 202 implements a multi-level memory hierarchy. In an embodiment, the memory partition unit 400 supports a unified memory to provide a single unified virtual address space for CPU and parallel processing unit 202 memory, enabling data sharing between virtual memory systems. In an embodiment the frequency of accesses by a parallel processing unit 202 to memory located on other processors is traced to ensure that memory pages are moved to the physical memory of the parallel processing unit 202 that is accessing the pages more frequently. In an embodiment, the NVLink 216 supports address translation services allowing the parallel processing unit 202 to directly access a CPU's page tables and providing full access to CPU memory by the parallel processing unit 202.

In an embodiment, copy engines transfer data between multiple parallel processing unit 202 modules or between parallel processing unit 202 modules and CPUs. The copy engines can generate page faults for addresses that are not mapped into the page tables. The memory partition unit 400 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 220 or other system memory may be fetched by the memory partition unit 400 and stored in the level two cache 404, which is located on-chip and is shared between the various general processing cluster 300 modules. As shown, each memory partition unit 400 includes a portion of the level two cache 404 associated with a corresponding memory 220 device. Lower level caches may then be implemented in various units within the general processing cluster 300 modules. For example, each of the streaming multiprocessor 500 modules may implement an L1 cache. The L1 cache is private memory that is dedicated to a particular streaming multiprocessor 500. Data from the level two cache 404 may be fetched and stored in each of the L1 caches for processing in the functional units of the streaming multiprocessor 500 modules. The level two cache 404 is coupled to the memory interface 406 and the crossbar 214.

The raster operations unit 402 performs graphics raster operations related to pixel color, such as color compression, pixel blending, and the like. The raster operations unit 402 also implements depth testing in conjunction with the raster engine 306, receiving a depth for a sample location associated with a pixel fragment from the culling engine of the raster engine 306. The depth is tested against a corresponding depth in a depth buffer for a sample location associated with the fragment. If the fragment passes the depth test for the sample location, then the raster operations unit 402 updates the depth buffer and transmits a result of the depth test to the raster engine 306. It will be appreciated that the number of partition memory partition unit 400 modules may be different than the number of general processing cluster 300 modules and, therefore, each raster operations unit 402 may be coupled to each of the general processing cluster 300 modules. The raster operations unit 402 tracks packets received from the different general processing cluster 300 modules and determines which general processing cluster 300 that a result generated by the raster operations unit 402 is routed to through the crossbar 214. Although the raster operations unit 402 is included within the memory partition unit 400 in FIG. 4, in other embodiment, the raster operations unit 402 may be outside of the memory partition unit 400. For example, the raster operations unit 402 may reside in the general processing cluster 300 or another unit.

FIG. 5 illustrates the streaming multiprocessor 500 of FIG. 3, in accordance with an embodiment. As shown in FIG. 5, the streaming multiprocessor 500 includes an instruction cache 502, one or more scheduler unit 504 modules (e.g., such as scheduler unit 208), a register file 506, one or more processing core 508 modules, one or more special function unit 510 modules, one or more load/store unit 512 modules, an interconnect network 514, and a shared memory/L1 cache 516.

As described above, the work distribution unit 210 dispatches tasks for execution on the general processing cluster 300 modules of the parallel processing unit 202. The tasks are allocated to a particular data processing cluster 312 within a general processing cluster 300 and, if the task is associated with a shader program, the task may be allocated to a streaming multiprocessor 500. The scheduler unit 208 receives the tasks from the work distribution unit 210 and manages instruction scheduling for one or more thread blocks assigned to the streaming multiprocessor 500. The scheduler unit 504 schedules thread blocks for execution as warps of parallel threads, where each thread block is allocated at least one warp. In an embodiment, each warp executes 32 threads. The scheduler unit 504 may manage a plurality of different thread blocks, allocating the warps to the different thread blocks and then dispatching instructions from the plurality of different cooperative groups to the various functional units (e.g., core 508 modules, special function unit 510 modules, and load/store unit 512 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 518 unit is configured within the scheduler unit 504 to transmit instructions to one or more of the functional units. In one embodiment, the scheduler unit 504 includes two dispatch 518 units that enable two different instructions from the same warp to be dispatched during each clock cycle. In alternative embodiments, each scheduler unit 504 may include a single dispatch 518 unit or additional dispatch 518 units.

Each streaming multiprocessor 500 includes a register file 506 that provides a set of registers for the functional units of the streaming multiprocessor 500. In an embodiment, the register file 506 is divided between each of the functional units such that each functional unit is allocated a dedicated portion of the register file 506. In another embodiment, the register file 506 is divided between the different warps being executed by the streaming multiprocessor 500. The register file 506 provides temporary storage for operands connected to the data paths of the functional units.

Each streaming multiprocessor 500 comprises L processing core 508 modules. In an embodiment, the streaming multiprocessor 500 includes a large number (e.g., 128, etc.) of distinct processing core 508 modules. Each core 508 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 508 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 508 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 500 also comprises M special function unit 510 modules that perform special functions (e.g., attribute evaluation, reciprocal square root, and the like). In an embodiment, the special function unit 510 modules may include a tree traversal unit configured to traverse a hierarchical tree data structure. In an embodiment, the special function unit 510 modules may include texture unit configured to perform texture map filtering operations. In an embodiment, the texture units are configured to load texture maps (e.g., a 2D array of texels) from the memory 220 and sample the texture maps to produce sampled texture values for use in shader programs executed by the streaming multiprocessor 500. In an embodiment, the texture maps are stored in the shared memory/L1 cache 516. The texture units implement texture operations such as filtering operations using mip-maps (e.g., texture maps of varying levels of detail). In an embodiment, each streaming multiprocessor 500 includes two texture units.

Each streaming multiprocessor 500 also comprises N load/store unit 512 modules that implement load and store operations between the shared memory/L1 cache 516 and the register file 506. Each streaming multiprocessor 500 includes an interconnect network 514 that connects each of the functional units to the register file 506 and the load/store unit 512 to the register file 506 and shared memory/L1 cache 516. In an embodiment, the interconnect network 514 is a crossbar that can be configured to connect any of the functional units to any of the registers in the register file 506 and connect the load/store unit 512 modules to the register file 506 and memory locations in shared memory/L1 cache 516.

The shared memory/L1 cache 516 is an array of on-chip memory that allows for data storage and communication between the streaming multiprocessor 500 and the primitive engine 314 and between threads in the streaming multiprocessor 500. In an embodiment, the shared memory/L1 cache 516 comprises 128 KB of storage capacity and is in the path from the streaming multiprocessor 500 to the memory partition unit 400. The shared memory/L1 cache 516 can be used to cache reads and writes. One or more of the shared memory/L1 cache 516, level two cache 404, and memory 220 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 516 enables the shared memory/L1 cache 516 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 2, are bypassed, creating a much simpler programming model. In the general purpose parallel computation configuration, the work distribution unit 210 assigns and distributes blocks of threads directly to the data processing cluster 312 modules. The threads in a block execute the same program, using a unique thread ID in the calculation to ensure each thread generates unique results, using the streaming multiprocessor 500 to execute the program and perform calculations, shared memory/L1 cache 516 to communicate between threads, and the load/store unit 512 to read and write global memory through the shared memory/L1 cache 516 and the memory partition unit 400. When configured for general purpose parallel computation, the streaming multiprocessor 500 can also write commands that the scheduler unit 208 can use to launch new work on the data processing cluster 312 modules.

The parallel processing unit 202 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 202 is embodied on a single semiconductor substrate. In another embodiment, the parallel processing unit 202 is included in a system-on-a-chip (SoC) along with one or more other devices such as additional parallel processing unit 202 modules, the memory 220, a reduced instruction set computer (RISC) CPU, a memory management unit (MMU), a digital-to-analog converter (DAC), and the like.

In an embodiment, the parallel processing unit 202 may be included on a graphics card that includes one or more memory devices. The graphics card may be configured to interface with a PCIe slot on a motherboard of a desktop computer. In yet another embodiment, the parallel processing unit 202 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 6 is a conceptual diagram of a processing system 600 implemented using the parallel processing unit 202 of FIG. 2, in accordance with an embodiment. The processing system 600 includes a central processing unit 602, switch 604, and multiple parallel processing unit 202 modules each and respective memory 220 modules. The NVLink 216 provides high-speed communication links between each of the parallel processing unit 202 modules. Although a particular number of NVLink 216 and interconnect 218 connections are illustrated in FIG. 6, the number of connections to each parallel processing unit 202 and the central processing unit 602 may vary. The switch 604 interfaces between the interconnect 218 and the central processing unit 602. The parallel processing unit 202 modules, memory 220 modules, and NVLink 216 connections may be situated on a single semiconductor platform to form a parallel processing module 606. In an embodiment, the switch 604 supports two or more protocols to interface between various different connections and/or links.

In another embodiment (not shown), the NVLink 216 provides one or more high-speed communication links between each of the parallel processing unit modules (parallel processing unit 202, parallel processing unit 202, parallel processing unit 202, and parallel processing unit 202) and the central processing unit 602 and the switch 604 interfaces between the interconnect 218 and each of the parallel processing unit modules. The parallel processing unit modules, memory 220 modules, and interconnect 218 may be situated on a single semiconductor platform to form a parallel processing module 606. In yet another embodiment (not shown), the interconnect 218 provides one or more communication links between each of the parallel processing unit modules and the central processing unit 602 and the switch 604 interfaces between each of the parallel processing unit modules using the NVLink 216 to provide one or more high-speed communication links between the parallel processing unit modules. In another embodiment (not shown), the NVLink 216 provides one or more high-speed communication links between the parallel processing unit modules and the central processing unit 602 through the switch 604. In yet another embodiment (not shown), the interconnect 218 provides one or more communication links between each of the parallel processing unit modules directly. One or more of the NVLink 216 high-speed communication links may be implemented as a physical NVLink interconnect or either an on-chip or on-die interconnect using the same protocol as the NVLink 216.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 606 may be implemented as a circuit board substrate and each of the parallel processing unit modules and/or memory 220 modules may be packaged devices. In an embodiment, the central processing unit 602, switch 604, and the parallel processing module 606 are situated on a single semiconductor platform.

In an embodiment, the signaling rate of each NVLink 216 is 20 to 25 Gigabits/second and each parallel processing unit module includes six NVLink 216 interfaces (as shown in FIG. 6, five NVLink 216 interfaces are included for each parallel processing unit module). Each NVLink 216 provides a data transfer rate of 25 Gigabytes/second in each direction, with six links providing 300 Gigabytes/second. The NVLink 216 can be used exclusively for PPU-to-PPU communication as shown in FIG. 6, or some combination of PPU-to-PPU and PPU-to-CPU, when the central processing unit 602 also includes one or more NVLink 216 interfaces.

In an embodiment, the NVLink 216 allows direct load/store/atomic access from the central processing unit 602 to each parallel processing unit module's memory 220. In an embodiment, the NVLink 216 supports coherency operations, allowing data read from the memory 220 modules to be stored in the cache hierarchy of the central processing unit 602, reducing cache access latency for the central processing unit 602. In an embodiment, the NVLink 216 includes support for Address Translation Services (ATS), enabling the parallel processing unit module to directly access page tables within the central processing unit 602. One or more of the NVLink 216 may also be configured to operate in a low-power mode.

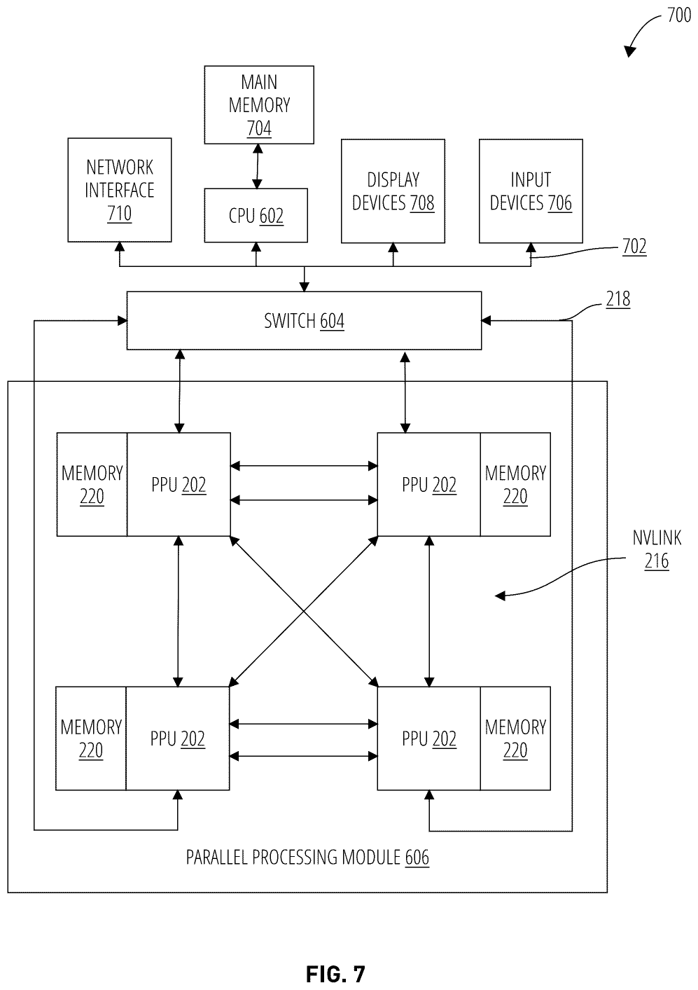

FIG. 7 depicts an exemplary processing system 700 in which the various architecture and/or functionality of the various previous embodiments may be implemented. As shown, an exemplary processing system 700 is provided including at least one central processing unit 602 that is connected to a communications bus 702. The communication communications bus 702 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 700 also includes a main memory 704. Control logic (software) and data are stored in the main memory 704 which may take the form of random access memory (RAM).

The exemplary processing system 700 also includes input devices 706, the parallel processing module 606, and display devices 708, e.g. a conventional CRT (cathode ray tube), LCD (liquid crystal display), LED (light emitting diode), plasma display or the like. User input may be received from the input devices 706, e.g., keyboard, mouse, touchpad, microphone, and the like. Each of the foregoing modules and/or devices may even be situated on a single semiconductor platform to form the exemplary processing system 700. Alternately, the various modules may also be situated separately or in various combinations of semiconductor platforms per the desires of the user.

Further, the exemplary processing system 700 may be coupled to a network (e.g., a telecommunications network, local area network (LAN), wireless network, wide area network (WAN) such as the Internet, peer-to-peer network, cable network, or the like) through a network interface 710 for communication purposes.

The exemplary processing system 700 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 704 and/or the secondary storage. Such computer programs, when executed, enable the exemplary processing system 700 to perform various functions. The main memory 704, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 700 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

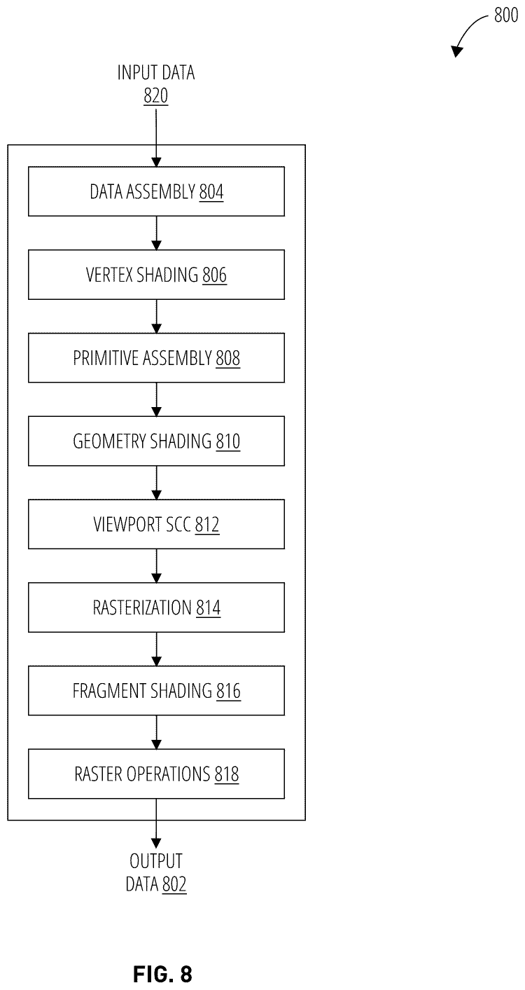

FIG. 8 is a conceptual diagram of a graphics processing pipeline 800 implemented by the parallel processing unit 202 of FIG. 2, in accordance with an embodiment. In an embodiment, the parallel processing unit 202 comprises a graphics processing unit (GPU). The parallel processing unit 202 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 202 can be configured to process the graphics primitives to generate a frame buffer (e.g., pixel data for each of the pixels of the display).

An application writes model data for a scene (e.g., a collection of vertices and attributes) to a memory such as a system memory or memory 220. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 500 modules of the parallel processing unit 202 including one or more of a vertex shader, hull shader, domain shader, geometry shader, and a pixel shader. For example, one or more of the streaming multiprocessor 500 modules may be configured to execute a vertex shader program that processes a number of vertices defined by the model data. In an embodiment, the different streaming multiprocessor 500 modules may be configured to execute different shader programs concurrently. For example, a first subset of streaming multiprocessor 500 modules may be configured to execute a vertex shader program while a second subset of streaming multiprocessor 500 modules may be configured to execute a pixel shader program. The first subset of streaming multiprocessor 500 modules processes vertex data to produce processed vertex data and writes the processed vertex data to the level two cache 404 and/or the memory 220. After the processed vertex data is rasterized (e.g., transformed from three-dimensional data into two-dimensional data in screen space) to produce fragment data, the second subset of streaming multiprocessor 500 modules executes a pixel shader to produce processed fragment data, which is then blended with other processed fragment data and written to the frame buffer in memory 220. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline 800 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 800 receives input data 601 that is transmitted from one stage to the next stage of the graphics processing pipeline 800 to generate output data 802. In an embodiment, the graphics processing pipeline 800 may represent a graphics processing pipeline defined by the OpenGL® API. As an option, the graphics processing pipeline 800 may be implemented in the context of the functionality and architecture of the previous Figures and/or any subsequent Figure(s).

As shown in FIG. 8, the graphics processing pipeline 800 comprises a pipeline architecture that includes a number of stages. The stages include, but are not limited to, a data assembly 804 stage, a vertex shading 806 stage, a primitive assembly 808 stage, a geometry shading 810 stage, a viewport SCC 812 stage, a rasterization 814 stage, a fragment shading 816 stage, and a raster operations 818 stage. In an embodiment, the input data 820 comprises commands that configure the processing units to implement the stages of the graphics processing pipeline 800 and geometric primitives (e.g., points, lines, triangles, quads, triangle strips or fans, etc.) to be processed by the stages. The output data 802 may comprise pixel data (e.g., color data) that is copied into a frame buffer or other type of surface data structure in a memory.

The data assembly 804 stage receives the input data 820 that specifies vertex data for high-order surfaces, primitives, or the like. The data assembly 804 stage collects the vertex data in a temporary storage or queue, such as by receiving a command from the host processor that includes a pointer to a buffer in memory and reading the vertex data from the buffer. The vertex data is then transmitted to the vertex shading 806 stage for processing.

The vertex shading 806 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 806 stage may manipulate individual vertex attributes such as position, color, texture coordinates, and the like. In other words, the vertex shading 806 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 806 stage generates transformed vertex data that is transmitted to the primitive assembly 808 stage.

The primitive assembly 808 stage collects vertices output by the vertex shading 806 stage and groups the vertices into geometric primitives for processing by the geometry shading 810 stage. For example, the primitive assembly 808 stage may be configured to group every three consecutive vertices as a geometric primitive (e.g., a triangle) for transmission to the geometry shading 810 stage. In some embodiments, specific vertices may be reused for consecutive geometric primitives (e.g., two consecutive triangles in a triangle strip may share two vertices). The primitive assembly 808 stage transmits geometric primitives (e.g., a collection of associated vertices) to the geometry shading 810 stage.

The geometry shading 810 stage processes geometric primitives by performing a set of operations (e.g., a geometry shader or program) on the geometric primitives. Tessellation operations may generate one or more geometric primitives from each geometric primitive. In other words, the geometry shading 810 stage may subdivide each geometric primitive into a finer mesh of two or more geometric primitives for processing by the rest of the graphics processing pipeline 800. The geometry shading 810 stage transmits geometric primitives to the viewport SCC 812 stage.

In an embodiment, the graphics processing pipeline 800 may operate within a streaming multiprocessor and the vertex shading 806 stage, the primitive assembly 808 stage, the geometry shading 810 stage, the fragment shading 816 stage, and/or hardware/software associated therewith, may sequentially perform processing operations. Once the sequential processing operations are complete, in an embodiment, the viewport SCC 812 stage may utilize the data. In an embodiment, primitive data processed by one or more of the stages in the graphics processing pipeline 800 may be written to a cache (e.g. L1 cache, a vertex cache, etc.). In this case, in an embodiment, the viewport SCC 812 stage may access the data in the cache. In an embodiment, the viewport SCC 812 stage and the rasterization 814 stage are implemented as fixed function circuitry.

The viewport SCC 812 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 814 stage.

The rasterization 814 stage converts the 3D geometric primitives into 2D fragments (e.g. capable of being utilized for display, etc.). The rasterization 814 stage may be configured to utilize the vertices of the geometric primitives to setup a set of plane equations from which various attributes can be interpolated. The rasterization 814 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 814 stage generates fragment data (e.g., interpolated vertex attributes associated with a particular sample location for each covered pixel) that are transmitted to the fragment shading 816 stage.

The fragment shading 816 stage processes fragment data by performing a set of operations (e.g., a fragment shader or a program) on each of the fragments. The fragment shading 816 stage may generate pixel data (e.g., color values) for the fragment such as by performing lighting operations or sampling texture maps using interpolated texture coordinates for the fragment. The fragment shading 816 stage generates pixel data that is transmitted to the raster operations 818 stage.

The raster operations 818 stage may perform various operations on the pixel data such as performing alpha tests, stencil tests, and blending the pixel data with other pixel data corresponding to other fragments associated with the pixel. When the raster operations 818 stage has finished processing the pixel data (e.g., the output data 802), the pixel data may be written to a render target such as a frame buffer, a color buffer, or the like.

It will be appreciated that one or more additional stages may be included in the graphics processing pipeline 800 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 810 stage). Other types of graphics processing pipelines are contemplated as being within the scope of the present disclosure. Furthermore, any of the stages of the graphics processing pipeline 800 may be implemented by one or more dedicated hardware units within a graphics processor such as parallel processing unit 202. Other stages of the graphics processing pipeline 800 may be implemented by programmable hardware units such as the streaming multiprocessor 500 of the parallel processing unit 202.

The graphics processing pipeline 800 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 202. The API provides an abstraction for a programmer that lets a programmer utilize specialized graphics hardware, such as the parallel processing unit 202, to generate the graphical data without requiring the programmer to utilize the specific instruction set for the parallel processing unit 202. The application may include an API call that is routed to the device driver for the parallel processing unit 202. The device driver interprets the API call and performs various operations to respond to the API call. In some instances, the device driver may perform operations by executing instructions on the CPU. In other instances, the device driver may perform operations, at least in part, by launching operations on the parallel processing unit 202 utilizing an input/output interface between the CPU and the parallel processing unit 202. In an embodiment, the device driver is configured to implement the graphics processing pipeline 800 utilizing the hardware of the parallel processing unit 202.

Various programs may be executed within the parallel processing unit 202 in order to implement the various stages of the graphics processing pipeline 800. For example, the device driver may launch a kernel on the parallel processing unit 202 to perform the vertex shading 806 stage on one streaming multiprocessor 500 (or multiple streaming multiprocessor 500 modules). The device driver (or the initial kernel executed by the parallel processing unit 202) may also launch other kernels on the parallel processing unit 202 to perform other stages of the graphics processing pipeline 800, such as the geometry shading 810 stage and the fragment shading 816 stage. In addition, some of the stages of the graphics processing pipeline 800 may be implemented on fixed unit hardware such as a rasterizer or a data assembler implemented within the parallel processing unit 202. It will be appreciated that results from one kernel may be processed by one or more intervening fixed function hardware units before being processed by a subsequent kernel on a streaming multiprocessor 500.

### LISTING OF DRAWING ELEMENTS

102 U-net network
104 encoder
106 decoder
108 skip connection
202 parallel processing unit
204 I/O unit
206 front-end unit
208 scheduler unit
210 work distribution unit
212 hub
214 crossbar
216 NVLink
218 interconnect
220 memory
300 general processing cluster
302 pipeline manager
304 pre-raster operations unit
306 raster engine
308 work distribution crossbar
310 memory management unit
312 data processing cluster
314 primitive engine
316 M-pipe controller
400 memory partition unit
402 raster operations unit
404 level two cache
406 memory interface
500 streaming multiprocessor
502 instruction cache
504 scheduler unit
506 register file
508 core
510 special function unit
512 load/store unit
514 interconnect network
516 shared memory/L1 cache
518 dispatch
600 processing system
602 central processing unit
604 switch
606 parallel processing module
700 exemplary processing system
702 communications bus
704 main memory
706 input devices
708 display devices
710 network interface
800 graphics processing pipeline
802 output data
804 data assembly
806 vertex shading
808 primitive assembly
810 geometry shading
812 viewport SCC
814 rasterization
816 fragment shading
818 raster operations
820 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A process for configuring an alias-free image-generating neural network comprising a plurality of translation equivariant layers, the process comprising training the layers to generate a denoising model by:
randomly sampling a time parameter from a continuous uniform distribution; and
randomly sampling a noise attribute from a continuous Gaussian process.

2. The process of claim 1, further comprising:
configuring the layers by minimizing, at a plurality of time positions, a distance metric between the noise attribute and a denoising model prediction.

3. The process of claim 2, wherein the denoising model operates on an input (αₜx₀+σₜg,t), wherein t is the time parameter, x₀ is the randomly sampled input, g represents a Gaussian process, σₜ is a time-dependent injected noise schedule, and αₜ is a time-dependent input rescaling coefficient.

4. The process of claim 2, wherein the distance metric is scaled by a time-dependent weight.

5. The process of claim 1, wherein Random Fourier Features is applied to derive the noise attribute.

6. The process of claim 1, wherein the neural network comprises a U-net.

7. The process of claim 6, wherein the U-Net is configured to be input translation equivariant.

8. The process of claim 1, further comprising:
training the denoising model D_{θ} to minimize
$${min}_{θ} {‖ T ( {D}_{θ} ( {x}_{t} , t ) ) - {D}_{θ} ( T ( {x}_{t} ) , t ) ‖}_{2}^{2}$$
where xₜ is a sample at time t and T is a randomizing transformation or an affine transformation.

9. A neural network comprising:
an encoder stage;
a decoder stage; and
thestages comprising a plurality of translation equivariant layers configured to implement an image denoising model by:
randomly sampling a time parameter from a continuous uniform distribution; and
randomly sampling a noise attribute from a continuous Gaussian process.

10. The neural network of claim 9, wherein the stages are configured by minimizing, at a plurality of time positions, a distance metric between the noise attribute and a denoising model prediction.

11. The neural network of claim 10, wherein the denoising model operates on an input (αₜx₀+σₜg,t), wherein t is the time parameter, x₀ is the randomly sampled input, g represents a Gaussian process, σₜ is a time-dependent injected noise schedule, and at is a time-dependent input rescaling coefficient.

12. The neural network of claim 10, wherein the distance metric is scaled by a time-dependent weight.

13. The neural network of claim 9, wherein Random Fourier Features is applied to derive the noise attribute.

14. The neural network of claim 9, further comprising a U-net.

15. The neural network of claim 14, wherein the U-Net is configured to be input translation equivariant.

16. The neural network of claim 9, wherein the denoising model D_{θ} is configured to minimize
$${min}_{θ} {‖ T ( {D}_{θ} ( {x}_{t} , t ) ) - {D}_{θ} ( T ( {x}_{t} ) , t ) ‖}_{2}^{2}$$
where xₜ is a sample at time t and T is a randomizing transformation or an affine transformation.

17. A computer system comprising:
at least one graphics processing unit; and
a non-volatile machine memory configured with instructions that, when applied to the graphics processing unit, configure the computer system to configure an alias-free image-generating neural network comprising a plurality of translation equivariant layers as a denoising model by:
randomly sampling a time parameter from a continuous uniform distribution; and
randomly sampling a noise attribute from a continuous Gaussian process.

18. The computer system of claim 17, wherein the instructions, when applied to the graphics processing unit, further configure the computer system to:
configure the neural network by minimizing, at a plurality of time positions, a distance metric between the noise attribute and a denoising model prediction.

19. The computer system of claim 18, wherein the wherein the instructions, when applied to the graphics processing unit, further configure the denoising model to operate on an input (αₜx₀+σₜg,t), wherein t is the time parameter, x₀ is the randomly sampled input, g represents a Gaussian process, σₜ is a time-dependent injected noise schedule, and αₜ is a time-dependent input rescaling coefficient.

20. The computer system of claim 18, wherein the distance metric is scaled by a time-dependent weight.
